(19) United States
(12) Patent Application Publication
(10) Pub. No.: US 2009/0178566 A1
(43) Pub. Date: Jul. 16, 2009

(54) HONEYCOMB ADSORBENTS FOR VAPOR RECOVERY SYSTEMS

(75) Inventors: Michael F. Tschantz, Lexington, VA (US); Roger S. Williams, Daniel Island, SC (US); S. Edward Woodcock Jr., Daniel Island, SC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Glen Allen, VA (US)

(21) Appl. No.: 12/295,126

(22) PCT Filed: Apr. 11, 2007
(86) PCT No.: PCT/US07/66361

§ 371 Date: Sep. 29, 2008

Related U.S. Application Data
(60) Provisional application No. 60/746,924, filed on May 10, 2006.

(51) Int. Cl. B01D 53/02; B01D 53/74

(52) U.S. Cl. 96/144; 96/154; 96/153

(57) ABSTRACT

The present invention relates to adsorption vapor recovery systems for recovering vaporized gasoline, distillates, benzene, solvents and the like from vapor mixtures, including at least one adsorber containing honeycomb adsorbents.

This non-provisional application relies on the filing date of provisional U.S. Application Ser. No. 60/746,924 filed on May 10, 2006, which is incorporated herein by reference, having been filed within twelve (12) months thereof, and priority thereto is claimed under 35 USC § 119(e).

### BACKGROUND OF THE INVENTION

In the storage and transfer of liquids formed from condensable compounds such as handling of petroleum fuel products at gasoline bulk terminals and refineries, portions of the liquids often vaporize and mix with air or other gas in contact therewith. Such mixtures generally cannot be vented directly to the atmosphere due to the resulting pollution of the environment or the creation of a fire or explosion hazard.

The term “condensable compounds” in the present invention refers to compounds which when in vapor state, can be condensed at a temperature in the range of from about 0° F. to about 150° F. and a pressure in the range of from about atmospheric to about 25 psig. Examples of such condensable compounds include, but are not limited to, methanol, benzene, toluene, methyl t-butyl ether (MTBE), acetone, carbon tetrachloride, hexane, kerosene, gasoline and the like. They may be produced from multi-compound hydrocarbon liquids such as gasoline and kerosene; single compound hydrocarbon liquids such as benzene and methanol; and non-hydrocarbon compounds such as carbon tetrachloride and the like.

The term “vapor mixture” in the present invention refers to a vapor mixture of condensable compounds and other gases such as air and the like.

A variety of processes have been developed and used for removing condensable compound vapors from vapor mixtures. The removed condensable compounds are generally liquified and recombined with the liquid from which they were vaporized, thereby making their recovery economically advantageous.

U.S. Pat. No. 4,276,058 teaches a recovery system that has been used commercially for both hydrocarbon and non-hydrocarbon condensable compounds from air-condensable compound vapor mixtures. The flow of air-condensable compound mixture is passed through a bed of solid adsorbent having an affinity for condensable compounds. As the mixture passes through the bed, a major portion of the condensable compounds contained in the mixture is adsorbed on the bed, and a residue gas stream is produced which is substantially free of condensable compounds and as a result can be vented to the atmosphere. While a first bed of the solid adsorbent is adsorbing condensable compounds from the vapor mixture, a second bed of solid adsorbent having condensable compounds adsorbed thereon is regenerated by evacuation. The evacuation is accomplished by vacuum pumping using a liquid seal vacuum pump, in combination with the introduction of a small quantity of heated condensable compound-free air into the solid adsorbent so that additional adsorbed compounds are stripped therefrom. The air-condensable compound vapor mixture produced in the regeneration of the solid adsorbent is contacted with a liquid absorbent, so that a major portion of the condensable compounds is absorbed therefrom and recovered. The flow pattern of the inlet vapor mixture and the bed of solid adsorbent being regenerated are periodically changed so that when the bed through which the inlet vapor mixture is flowing becomes loaded with adsorbed hydrocarbons or other condensable compounds, the inlet vapor mixture is caused to flow through the bed which has just been regenerated.

The commonly used adsorbent for an adsorption vapor recovery system is activated carbon, in either granular or pelletized forms. Granular activated carbon is available in many size ranges, for example, 8×35 mesh, 12×30 mesh, 10×25 mesh, 4×14 mesh, and 6×18 mesh. For pelletized activated carbon, a typical pellet size of 2 mm may be used. Pellets are usually cylindrical with diameters ranging from about 1 mm to about 4 mm. The size ranges of pellets and granules may overlap. Pellets are typically extruded, and thus may have a fairly uniform or regular shape, and may be more durable due to the presence of binder.

It is possible for gas flow to be unevenly distributed (so-called channeling) in the adsorbent bed filled with granular and/or pelletized carbon, resulting in a reduction of the adsorber efficiency. Furthermore, granular and pelletized carbons are prone to settling which could lead to a short-circuiting of flow through the bed and a resulting loss in adsorption efficiency. The high pressure drop of vapor mixture passing through the absorbent bed filled with granular and/or pelletized activated carbon also presents processing difficulty in operating the recovery system effectively.

Therefore, there is still a need for a recovery system using adsorbent beds filled with the adsorbent having improved adsorption effectiveness to granular and pelletized activated carbon, so that a reduced amount of absorbent is required and the recovery system may be smaller in system footprint.

There is also a need for a recovery system with lower pressure drops without the sacrifice of decreased mass transfer kinetics, i.e. adsorption and desorption rates, and thus enhance energy efficiency and economy for operating such a system.

Furthermore, it is desirable to use a more physically durable adsorbent to minimize, if not completely eliminate, the channeling in the absorbent beds in order to enhance the efficiency and maintain bed restriction consistently for the recovery system.

It is an object of the present invention to provide a process for recovering condensable compounds from vapor mixtures that uses adsorbents having enhanced efficiency.

It is another object of the present invention to provide an adsorption vapor recovery system having improved energy efficiency.

It is yet another object of the present invention to provide an adsorption vapor recovery system requiring lower absorbent amount and smaller system footprint.

It is a further object of the present invention to provide an adsorption vapor recovery system having minimized hot spot and lowered possibility of bed fires.

It is yet a further object of the present invention to provide an adsorption vapor recovery system that its capacity can be easily incrementally increased.

Other objects, features and advantages of the present invention will be set forth in part in the description in conjunction with the accompanying drawings which follows, and in part will be readily apparent to those skilled in the art from the description or may be learned by practice of the invention.

### SUMMARY OF THE INVENTION

The present invention relates to adsorption vapor recovery systems for recovering vaporized gasoline, distillates, benzene, solvents and the like from vapor mixtures, including at least one adsorber containing honeycomb adsorbent.

### BRIEF DESCRIPTION OF THE DRAWINGS

FIG. 1 is a schematic illustration of a vapor adsorber unit;

FIG. 2 is a schematic illustration of a honeycomb adsorbent;

FIG. 3 is a graph showing pressure drop of adsorbent beds containing different adsorbents: 200 cpsi honeycomb activated carbon, 400 cpsi honeycomb activated carbon, 12×30 mesh granular activated carbon, and 2 mm pelletized activated carbon;

FIG. 4 is a schematic illustration of honeycomb adsorbent in a vapor adsorber in one embodiment of the invention; and

FIG. 5 is a schematic illustration of honeycomb adsorbent in a vapor adsorber in another embodiment of the invention; and

FIG. 6 is a schematic illustration of honeycomb adsorbent in a vapor adsorber in yet another embodiment of the invention.

### DETAILED DESCRIPTION OF THE INVENTION

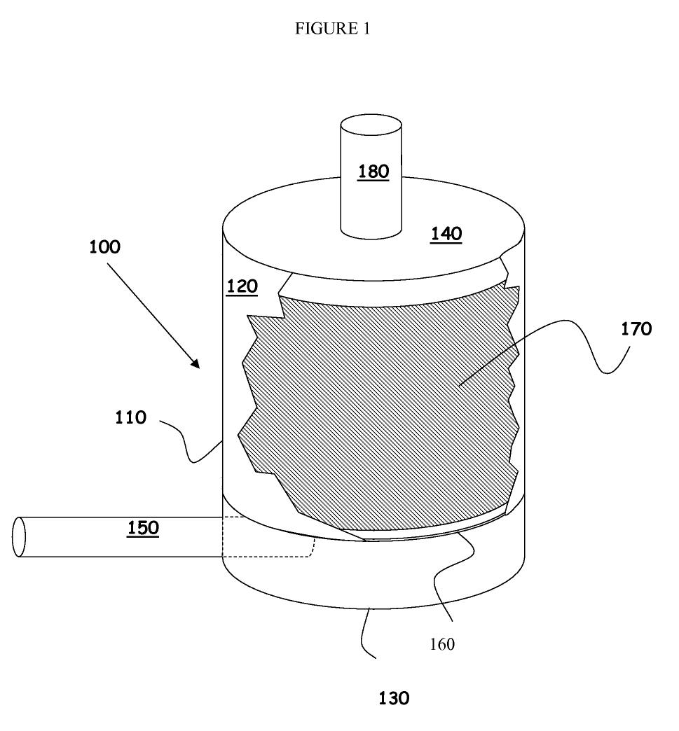

FIG. 1 illustrates a cutaway view of a typical adsorbent bed 100. A vessel 110 has a vessel wall 120 (shown in cutaway), a vessel bottom 130, a vessel top 140, filling materials 170 comprising adsorbent such as activated carbon, and optionally a support 160 such as a screen. The flow of inlet vapor mixture enters the vessel through pipe 150, passes through the adsorbent material 170 in the vessel, and exits through pipe 180. It is to be understood, however, that any other adsorbent bed structures may be used in the present invention.

The flow of inlet vapor mixture is passed through a bed of adsorbents including at least one honeycomb adsorbent having an affinity for the condensable compounds. As the vapor mixture passes through the bed, a major portion of the condensable compounds in the vapor mixture is adsorbed on the bed, and a residue gas stream is produced which is substantially free of condensable compounds and can be vented to the atmosphere or otherwise used or disposed of. While a first bed of the solid adsorbent is adsorbing condensable compounds from the vapor mixture, a second bed of adsorbent including at least honeycomb adsorbent having condensable compounds adsorbed thereon is regenerated. A major portion of the condensable compounds is desorbed from the bed, producing a vapor mixture rich in condensable compounds that is then condensed to the condensable compounds. As a result, the condensable compound is recovered from the vapor mixture. The flow pattern of the inlet vapor mixture and the bed of adsorbents being evacuated are periodically changed, whereby when the bed through which the inlet vapor is flowing becomes loaded with adsorbed condensable compounds, the inlet vapor mixture is caused to flow through the bed which has just been evacuated and the bed loaded with adsorbed condensable compounds is caused to be regenerated.

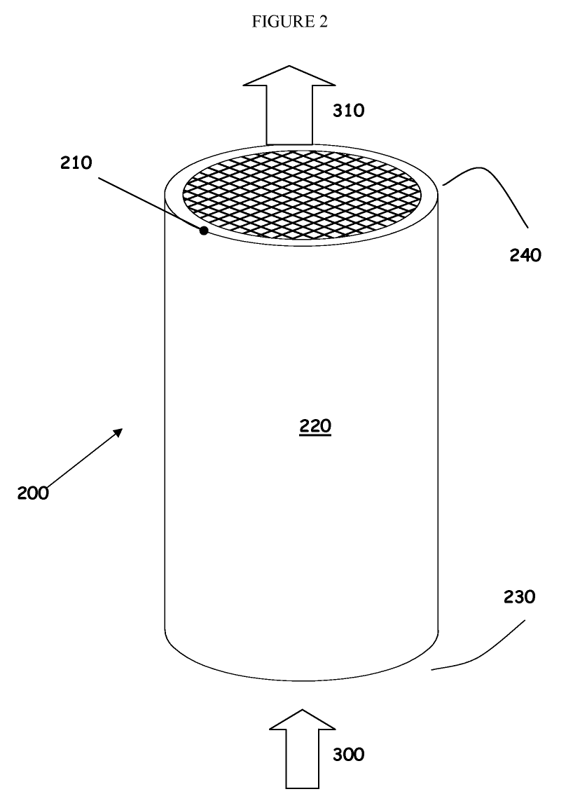

FIG. 2 illustrates one embodiment of the invention honeycomb having a wall 220, a first end 230, and a second end 240. Here the honeycomb is a round cylinder, but it is to be understood that other honeycomb shapes may be used in the present invention such as oval, square, and rectangular cylinders.

The honeycomb adsorbent suitable for use in the present invention may be produced by any methods known in art. These honeycomb adsorbents may include, but are not limited to, activated carbon, silica, zeolite, activated alumina, and combinations thereof. Furthermore, the honeycomb may include material assisting in forming and/or retaining its honeycomb shape. Examples of such known assisting materials include, but are not limited to, ceramic material such as clay and cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

The activated carbon honeycomb may be produced by shaping a mixture of activated carbon and aforementioned assisting material(s) into honeycomb structure. The mixture may be extruded into honeycomb structure as described in U.S. Pat. Nos. 5,914,294; 6,171,373; and 6,284,705. Additionally, the mixture may be formed into honeycomb structure through pressure molding as described in U.S. Pat. No. 4,518,704. After formed into the honeycomb structure, the mixture may be heated to a high temperature in an inert or oxidizing atmosphere to form the final product. When ceramic-based compound is used as an assisting material, the honeycomb adsorbent itself may also act as a heat sink to moderate temperature increases during adsorption cycle and as a heat source to moderate temperature decreases during regeneration cycle to further enhance the cycle efficiency. Additionally, ceramic may contribute strength and stability to the honeycomb.

The activated carbon honeycomb may also be produced by impregnating or depositing carbon precursor onto a honeycombic structure made of the aforementioned assisting material(s), curing and/or carbonizing the carbon precursor to form a uniform adherent continuous coating of carbon on the honeycomb structure, and finally activating the carbon as described in the U.S. Pat. Nos. 5,750,026 and 6,372,289.

Additionally, the activated carbon honeycomb may be produced by impregnating or depositing activated carbon onto a honeycombic structure made of the aforementioned assisting material(s). For example, U.S. Pat. No. 4,992,319 describes a method of producing activated carbon honeycomb by dipping an inorganic fiber made paper in a suspension of fine particulate activated carbon and a binder or coating the suspension over the inorganic fiber made paper; drying the paper so that the activated carbon will fill the voids between the fibers in the paper; superposing sheets of the activated carbon filled paper alternately with corrugated sheets of the same paper; and bonding the individual sheets together with an adhesive to form a honeycomb structure.

Suitable activated carbon for use as an adsorbent in the present invention may be derived from any carbon sources known in art. These include, but are not limited to, wood, cotton linters, peat, coal, coconut, lignite, carbohydrates, petroleum pitch, petroleum coke, coal tar pitch, fruit pits, nut shells, nut pits, sawdust, wood flour, synthetic polymer, and natural polymer, and combinations thereof. Furthermore, the activated carbon may be produced using a variety of processes including, but are not limited to, chemical activation, thermal activation, and combinations thereof.

In one embodiment of the present invention, a bank of 3-8 inch honeycomb tubes is used to enhance the efficiency of heat transfer. The invention adsorber may include at least one bank of multiple honeycomb tubes having a diameter of about 3-8 inches, manifolded together to operate in parallel as a single unit. This adsorber has several beneficial performances including, but are not limited to, an improved transfer of heat into the honeycombs to reduce temperature swings within the honeycombs resulting from adsorption and desorption of vapors. Furthermore, the honeycomb portion may be switched out easily. As a result, the capacity of the vapor recovery system may be incrementally increased simply by adding more honeycomb tube modules, and in some cases, along with increasing vacuum pump capacity if needed.

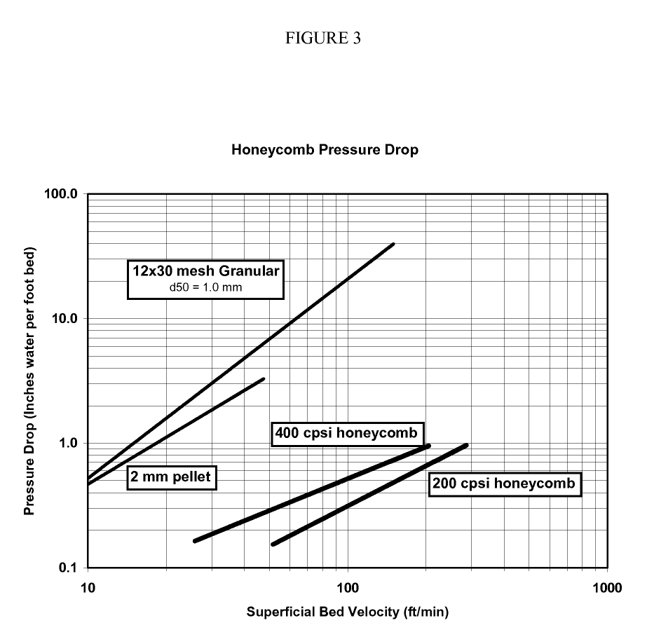

FIG. 3 shows comparative pressure drop curves of the invention adsorbent bed containing honeycomb activated carbon adsorbent and the known adsorbent beds containing granular or pelletized activated carbon adsorbent. For a given superficial air velocity per unit cross section of the absorbent bed, the pressure drop of an adsorbent bed containing 200 cell per square inch (cpsi) honeycomb is about 30 times lower than of that of an adsorbent bed containing 2 mm pellets and about 50 times lower than that of an adsorbent bed containing 12×30 mesh granules.

Honeycomb adsorbent has much thinner cell walls relative to the particle diameters of pelletized and granular adsorbents. The cell walls of 200 cspi and 400 cpsi honeycombs are about 0.4 mm, versus about 2 mm for a 2 mm pellet and about 0.2-1 mm for the granule. During adsorption and desorption, the adsorbed or desorbed vapors may travel up to about 0.2 mm when the honeycomb is used as adsorbent, versus up to 1 mm when a pellet is employed. The shorter distances for internal diffusional mass transfer as denoted for the honeycomb adsorbent leads to faster saturation and desorption rates and thus shorter cycle times.

Honeycomb adsorbent of the present invention can be purged quickly with vacuum. In one embodiment, the honeycomb adsorbent may be purged using a vacuum above 100 mbar, compared to 80 mbar or less typically required for the known system. Furthermore, the invention vapor recovery system may be closely timed with the actual truck loading process. Lower vacuum level required for purging and ability to be closely time with the loading process allow the invention vapor recovery system to be used at reduced energy level.

Since pressure drop through the honeycomb is lower than through granular or pelletized activated carbon and since the diffusional mass transfer zone through the honeycomb wall is shorter, the evacuation of adsorbed hydrocarbon-free vapor from a loaded adsorbent may be achieved using lower evacuation force and energy than that required for granular or pelletized adsorbents, such as using smaller vacuum pump.

Additionally, the mean particle diameter of activated carbon within the honeycomb adsorbents is much smaller than those of other activated carbon forms. The typical mean particle diameter of the honeycomb activated carbon is about 17 microns, whereas that of granular carbon is about 1 mm. Hence, the honeycomb has much higher specific surface area (area per unit mass of carbon) compared to other carbon structures.

The vacuum break is a primary source of carbon attrition in vapor recovery units. The honeycomb absorbent has higher isostatic strength compared to granular and pelletized carbons, and thus lower level of carbon attrition. As a result, the costs of carbon rescreening and/or replacement may be reduced or eliminated when honeycomb adsorbents are used. Moreover, the pressure buildup and potential dust-related problems due to carbon attrition may also be minimized.

In the present invention, the adsorbent used in the bed may be honeycomb solely or only in part by using honeycomb in combination of other adsorbent structures including, but not limited to, granular and pellet.

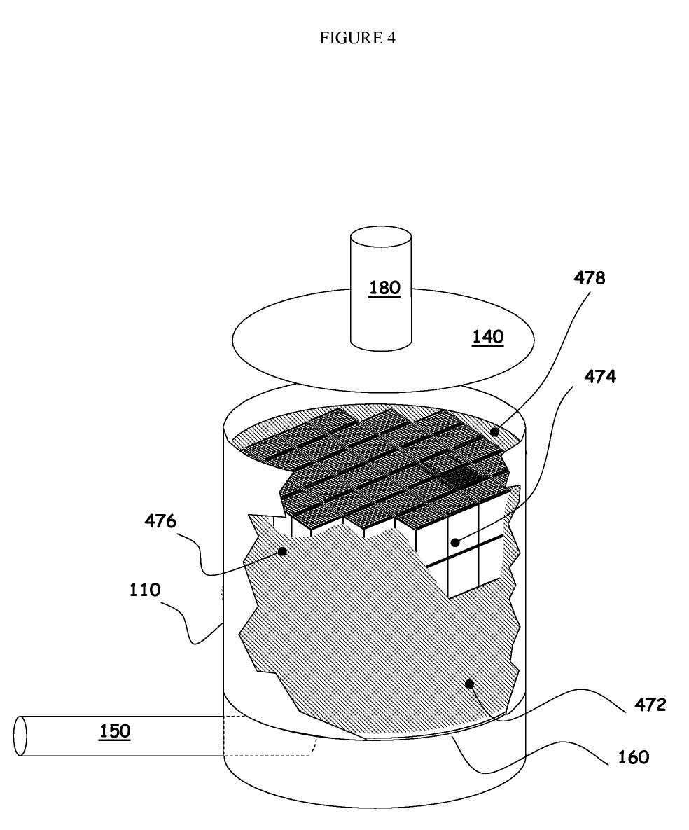

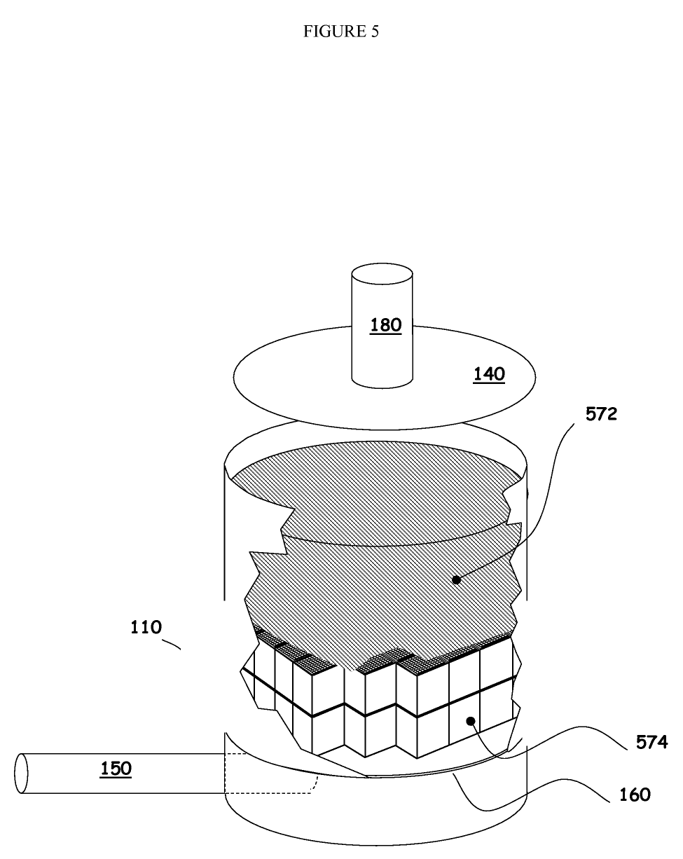

In one embodiment of the present invention, honeycomb adsorbent is used in combination with carbon granules and/or pellets in the adsorbent bed. In FIG. 4, the inlet portion of the adsorbent bed is filled with granular and/or pelletized carbon 472, and the later portion of the adsorbent bed is filled with carbon honeycombs 474. In FIG. 5, the inlet portion of the adsorbent bed is filled with carbon honeycombs 574, and the later portion of the adsorbent bed is filled with granular and/or pelletized carbon 572. The honeycombs may be rectangular in cross section as shown and bonded together in blocks to fill the cross section. Nonetheless, it is to be understood that other cross sectional shapes may also be used. In some instances, it may be necessary to fill some peripherals spaces such as those 476 and 478 shown in FIG. 4 with specially shaped honeycomb pieces, granular and/or pelletized carbons.

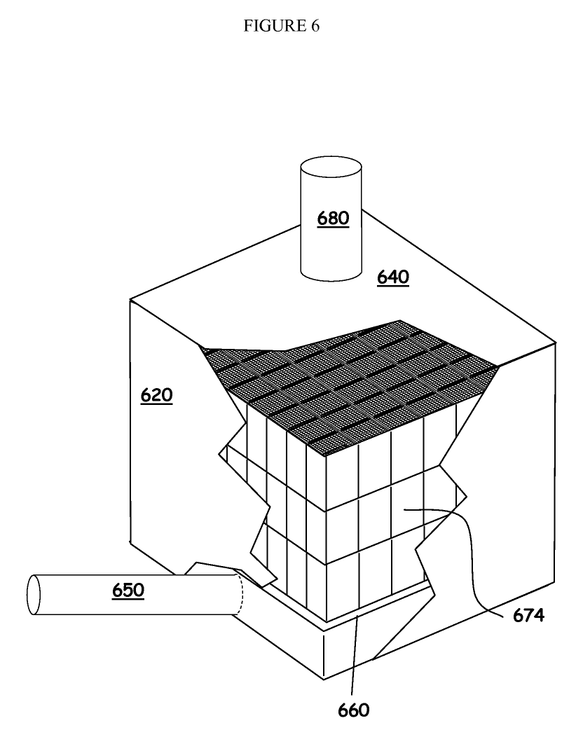

In another embodiment of the present invention, honeycomb adsorbent is used solely in the adsorbent bed as, for example, shown in FIG. 6.

Methods of making and using honeycombs in accordance with the invention should be readily apparent from the mere description of the structure and its varied appearances as provided herein. No further discussion or illustration of such methods, therefore, is deemed necessary.

It is to be understood that the foregoing description relates to embodiments are exemplary and explanatory only and are not restrictive of the invention. Any changes and modifications may be made therein as will be apparent to those skilled in the art. Such variations are to be considered within the scope of the invention as defined in the following claims.

What is claimed is:

1. A vapor recovery system including at least one adsorber containing adsorbent, wherein the adsorbent comprises honeycomb adsorbent.

2. The system of claim 1, wherein the honeycomb adsorbent comprises at least one member selected from the group consisting of activated carbon, silica, zeolite, activated alumina, and combinations thereof.

3. The system of claim 2, wherein a precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer.

4. The system of claim 2, wherein the activated carbon is obtained from a process comprising activation process selected from the group consisting of chemical, thermal, and combinations thereof.

5. The system of claim 1, wherein the honeycomb adsorbent comprises material assisting in forming and/or retaining the honeycomb shape.

6. The system of claim 5, wherein the assisting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

7. The system of claim 1, wherein the honeycomb has a pore size range of about 10 angstrom to about 2,000 angstrom, and a BET surface area range of about 200 m²/gm to about 3000 m²/gm.

8. The system of claim 1, wherein the adsorbent is solely honeycomb.

9. The system of claim 1, wherein the adsorbent is a combination of honeycomb and at least one non-honeycomb adsorbent.

10. The system of claim 10, wherein the non-honeycomb adsorbent comprises at least one member selected from the group consisting of granules, pellets, and combinations thereof.

11. The system of claim 1, wherein the vapor comprises at least one member selected from the group consisting of gasoline vapors, distillate vapors, benzene vapor, chlorinated vapors, hydrocarbon solvent vapors, alcohol vapors, and combinations thereof.

12. A vapor recovery system comprising:
(a) at least one adsorber containing adsorbent and having first and second connections, wherein the adsorbent comprises honeycomb adsorbent;
(b) a first conduit means connected to a first connection of an adsorber for conducting a vapor mixture to said adsorber and for evacuating said adsorber;
(c) a valve means disposed in said first conduit means for selectively causing the vapor mixture to flow through one or an other adsorber;
(d) a second conduit means connected to a second connection of said adsorber for conducting residue vapor exiting said adsorber to an atmosphere;
(e) a second valve means disposed in a second conduit means for selectively causing said second connection of one or an other adsorber to open to the atmosphere;
(f) evacuating means for desorbing said adsorbent;
(g) a third conduit means connected between said evacuation means and said first conduit means connected to an adsorber; and
(h) a third valve means disposed in said third conduit means for selectively communicating one or an other adsorber with said evacuating means.

13. The system of claim 12, wherein the honeycomb adsorbent comprises at least one member selected from the group consisting of activated carbon, silica, zeolite, activated alumina, and combinations thereof.

14. The system of claim 13, wherein a precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer.

15. The system of claim 13, wherein the activated carbon is obtained from a process comprising activation process selected from the group consisting of chemical, thermal, and combinations thereof.

16. The system of claim 12, wherein the honeycomb adsorbent comprises material assisting in forming and/or retaining the honeycomb shape.

17. The system of claim 16, wherein the assisting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

18. The system of claim 12, wherein the honeycomb has a pore size range of about 10 angstrom to about 2,000 angstrom, and a BET surface area range of about 200 m²/gm to about 3000 m²/gm.

19. The system of claim 12, wherein the adsorbent is solely honeycomb.

20. The system of claim 12, wherein the adsorbent is a combination of honeycomb and at least one non-honeycomb adsorbent.

21. The system of claim 20, wherein the non-honeycomb adsorbent comprises at least one member selected from the group consisting of granules, pellets, and combinations thereof.

22. The system of claim 12, wherein the vapor comprises at least one member selected from the group consisting of gasoline vapors, distillate vapors, benzene vapor, chlorinated vapors, hydrocarbon solvent vapors, alcohol vapors, and combinations thereof.

23. The system of claim 12, wherein the second conduit means include destruction means to reduce a level of volatile content in the residue gas before emitting to atmosphere.

24. An adsorber, comprising at least one bank of multiple honeycomb adsorbent tubes manifolded together to operate in parallel as a single unit.

25. The adsorber of claim 24, wherein the honeycomb adsorbent tube has a diameter range of about 3 inch to about 8 inch.

26. The adsorber of claim 24, wherein the honeycomb adsorbent comprises at least one member selected from the group consisting of activated carbon, silica, zeolite, activated alumina, and combinations thereof.

27. The adsorber of claim 26, wherein a precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer.

28. The adsorber of claim 26, wherein the activated carbon is obtained from a process comprising activation process selected from the group consisting of chemical, thermal, and combinations thereof.

29. The adsorber of claim 24, wherein the honeycomb adsorbent comprises material assisting in forming and/or retaining the honeycomb shape.

30. The adsorber of claim 29, wherein the assisting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

31. The adsorber of claim 24, wherein the honeycomb has a pore size range of about 10 angstrom to about 2,000 angstrom, and a BET surface area range of about 200 m²/gm to about 3000 m²/gm.

32. A vapor recovery system including at least one adsorber, wherein the adsorber comprises at least one bank of multiple honeycomb adsorbent tubes manifolded together to operate in parallel as a single unit.

33. The system of claim 32, wherein the honeycomb adsorbent tube has a diameter range of about 3 inch to about 8 inch.

34. The system of claim 32, wherein the honeycomb adsorbent comprises at least one member selected from the group consisting of activated carbon, silica, zeolite, activated alumina, and combinations thereof.

35. The system of claim 34, wherein a precursor of the activated carbon comprises at least one material selected from the group consisting of wood, peat, coal, coconut, lignite, petroleum pitch, petroleum coke, coal tar pitch, fruit pits, nut shells, sawdust, wood flour, synthetic polymer, and natural polymer.

36. The system of claim 34, wherein the activated carbon is obtained from a process comprising activation process selected from the group consisting of chemical, thermal, and combinations thereof.

37. The system of claim 32, wherein the honeycomb adsorbent comprises material assisting in forming and/or retaining the honeycomb shape.

38. The system of claim 37, wherein the assisting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

39. The system of claim 32, wherein the honeycomb has a pore size range of about 10 angstrom to about 2,000 angstrom, and a BET surface area range of about 200 m²/gm to about 3000 m²/gm.

40. The system of claim 32, wherein the vapor comprises at least one member selected from the group consisting of gasoline vapors, distillate vapors, benzene vapor, chlorinated vapors, hydrocarbon solvent vapors, alcohol vapors, and combinations thereof.
